(19) United States
(12) Patent Application Publication
(10) Pub. No.: US 2008/0298218 A1
(43) Pub. Date: Dec. 4, 2008

(54) ELECTRONIC DEVICE AND MANUFACTURING METHOD OF ELECTRONIC DEVICE

(75) Inventors: Hisao TANAKA, Kawasaki (JP); Seiichi SHIMOURA, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/052,043

(22) Filed: Mar. 20, 2008

(30) Foreign Application Priority Data
May 31, 2007 (JP) 2007-144562

(51) Int. Cl. G11B 7/00

(52) U.S. Cl. 369/126

(57) ABSTRACT

In the state in which a FPC terminal conductor precoated with a solder bump is opposed to a suspension terminal conductor having an Au plating layer, heating and melting is carried out while the suspension terminal conductor is pressed against the solder bump by a heater chip, thereby joining the FPC terminal conductor with the suspension terminal conductor by solder without using flux. In the suspension terminal conductor, a notch, a slit, or the like is formed as a solder joint observation window through which the solder joint state by the solder bump can be visually checked from outside via an insulating layer.

This application is a priority based on prior application No. JP 2007-144562, filed May 31, 2007, in Japan.

### BACKGROUND OF THE INVENTION

1. Field of the Invention

The present invention relates to an electronic device having a structure, in which terminals on each of which a plurality of terminal conductors are arranged on an insulating layer are mutually joined by soldering, and a manufacturing method of the electronic device and, particularly, relates to the electronic device, in which the terminals are mutually joined by soldering without using flux, and a manufacturing method of the electronic device.

2. Description of the Related Arts

Conventionally, as electrical connection between a suspension terminal of a head gimbal assembly which is a component part of a hard disk drive and a base terminal of a flexible printed board on which a head IC is mounted, a method of mutually joining Au terminals by ultrasonic waves is known; and, recently, a method of precoating one of the Au terminals with a solder bump and carrying out solder joining by thermal compression bonding without using flux is used. Such electrical connection techniques of a connection terminal of a tail part of a suspension on which a slider (head) for reading/writing of a magnetic disk is mounted and a base terminal of a flexible printed board on which a head IC having a preamp function is mounted are core techniques, including the structures thereof, in assembling of a hard disk drive. The merits of the change from the conventional ultrasonic wave joining between Au terminals to solder joining include the following points. First of all, an ultrasonic wave application apparatus needed for mutually joining the Au terminals becomes unnecessary, and the cost of equipment is reduced. Secondly, the terminals of the same head gimbal assembly and the terminals of an adjacent head gimbal assembly can be joined at one time, and the takt time (process operation time) can be suppressed. Thirdly, repairment such as re-attachment at the same location can be carried out by re-melting of solder. Fourth, the joint strength of the solder joint is higher and stable, the durability against stress and impact stress is improved, and reliability is improved. Fifth, joint quality determination by appearance observation can be carried out, quality assurance is easy, and outflow of defective products can be reduced/prevented. In assembling and manufacturing of a hard disk drive, in order to prevent head crash, dust, and the like in the vicinities of a medium and a head have to be removed. Generally, soldering connection uses flux in order to ensure solder wettability; however, when solder joint is carried out by using flux in joint between a suspension tail terminal and a flexible printed board terminal, a cleaning process of removing a remaining flux residue has to be added. When the cleaning is not perfect, failure due to the flux residue may be caused, and a cleaning process having an enough margin planed when flux is used. In order to solve this problem, solder joint methods not using flux is carried out. In the fluxless solder joint methods, a flexible printed board terminal is precoated with a solder bump, a suspension tail terminal is caused to be an Au plated terminal, and heating and melting is carried out by a heater chip or the like in the state in which the suspension terminal is pressed against the solder bump of the flexible printed board terminal, thereby carrying out soldering and joint.

[Patent document 1] Japanese Patent Application Laid-Open Publication No. H11-191210
[Patent document 2] Japanese Patent Application Laid-Open Publication No. 2006-049751
[Patent document 3] Japanese Patent Application Laid-Open Publication No. 2005-011503

However, in such conventional solder joint not using flux, a sufficient amount of solder that keeps wettability and spreads to the suspension terminal upon solder joint is needed, and, at the same time, the solder amount of precoating as the solder bump has to be controlled so that short circuit does not occur with an adjacent terminal even when the solder is crushed and protrudes from the sides due to pressurizing. In order to determine whether it is the solder joint by such an appropriate solder amount, when, for example as shown in FIG. 1A, a suspension terminal 110 is viewed and protruding parts 118 of solder can be observed outside by visual examination after solder joint, it can be considered as an appearance non-defective product.

FIG. 1B shows a cross section of the solder joint, wherein, in a flexible board terminal 100, a terminal conductor 104 is disposed on a flexible film 102 serving as an insulating layer, and the upper side thereof is precoated with a solder bump. With respect to the flexible board terminal 100, a suspension terminal 110 is joined by soldering. In the suspension terminal 110, an electrode conductor 114 having an Au plated layer is disposed below an insulating layer 112. The flexible board terminal 100 is subjected to positioning with the suspension terminal 110, and the electrode conductor 114 is pressed against the solder bump precoated in the terminal conductor 104 side and heated and melted, thereby achieving joint by shown solder 116. In this case, a sufficient amount of the solder 116 is interposed between the flexible board terminal 100 and the suspension terminal 110, thereby providing the solder joint having the protruding parts 118. However, when the protruding parts of the solder cannot be observed even when the suspension terminal 110 is viewed like FIG. 2A, even if an appropriate amount of the solder 116 is interposed between the flexible board terminal 100 and the suspension terminal 110 and they are joined in the actual state as shown in the cross section of FIG. 2B, there is a problem that it has to be determined to be an appearance defective product since it cannot be checked. The conventional solder joint which does not use flux has a structure in which solder is two-dimensionally (planarly) joined with the terminal surfaces, wherein, although the joint strength is high in the joint surface direction, the joint strength in the exfoliation direction orthogonal to the joint surfaces is low compared with that; and, particularly as the suspension terminal that is used in a rotary actuator driven for positioning and moving a head with respect to a magnetic disk and undergoes vibrations, and the like, further improvement in the joint strength is desired.

### SUMMARY OF THE INVENTION

According to the present invention to provide an electronic device which improves the appearance examination performance and joint strength of the solder joint structure not using flux so as to improve the manufacturing yield and a manufacturing method of the electronic device.

### (Electronic Device)

The present invention provides an electronic device having a solder joint structure not using flux.

The electronic device of the present invention includes

a first terminal unit having a plurality of first terminal conductors arranged on a first insulating layer, a cover layer coating both ends of a surface of the first terminal conductor, and a solder bump precoating an exposed surface of the first terminal conductor;

a second terminal unit having a plurality of second terminal conductors, which are arranged on a second insulating layer so as to be opposed to the first terminal conductors, and an Au plating layer plated on a surface of the second terminal conductor; and

a solder joint structure in which, in the state in which the second terminal conductor of the second terminal unit is opposed to the first terminal conductor of the first terminal unit, heating and melting is carried out while the first terminal conductor is pressed against the solder bump so as to join the first terminal conductor with the second terminal conductor by soldering without using flux.

In such an electronic device, the present invention has a characteristic that a solder joint observation window through which the solder joint state by the solder bump can be visually checked from outside via the second insulating layer is provided on the second terminal conductor.

The solder joint observation window of the second terminal conductor forms a notch or a slit through which the solder joint state by the solder bump can be visually checked from outside via the second insulating layer within a range opposed to the outline shape of the first terminal conductor.

As the solder joint observation window of the second terminal conductor, a notch is formed at a center of a long side of the terminal conductor, which is rectangular, so that a solder fillet that enters the notch can be visually checked from outside via the second insulating layer. The notch is rectangular, triangular, or semi-circular.

As the solder joint observation window of the second terminal conductor, a slit is bored at the center of the rectangular terminal conductor so that a solder fillet that enters the slit can be visually checked from outside via the second insulating layer. The slit is rectangular, oval, circular, or arrangement of a plurality of circles.

As the solder joint observation window of the second terminal conductor, a long side of the terminal conductor, which is rectangular, is formed into a wave shape so that a solder fillet that enters a concave part of the wave shape can be visually checked from outside via the second insulating layer.

As the solder joint observation window of the second terminal conductor, a long side of the terminal conductor, which is rectangular, is formed into a wave shape, and a slit is bored at the center so that a solder fillet that enters the concave part of the wave shape and the slit can be visually checked from outside via the second insulating layer.

As the solder joint observation window of the second terminal conductor, a long side of the terminal conductor, which is rectangular, is formed into a comb tooth shape so that a solder fillet that enters the comb tooth shape can be visually checked from outside via the second insulating layer.

As the solder joint observation window of the second terminal conductor, a long side of the terminal conductor, which is rectangular, is formed into a comb tooth shape, and a slit is bored at the center so that a solder fillet that enters the comb tooth shape and the slit can be visually checked from outside via the second insulating layer.

The planar shape of the first terminal conductor and the second terminal conductor is circular, and as the solder joint observation window of the second terminal conductor, one or a plurality of notch is formed in the outer periphery of the circular terminal conductor so that a solder fillet that enters the notch can be visually checked from outside via the second insulating layer.

The electronic device is a magnetic disk apparatus which moves a head to an arbitrary position of a disk medium by a rotary actuator and records or reproduces data;

The first terminal unit is provided on a flexible printed board of which one end is fixed to the rotary actuator and the other end thereof is connected to a circuit unit in a chassis fixed side;

the second terminal unit is provided in the tail unit of a suspension supporting the head with respect to the rotary actuator; and

the first terminal unit of the flexible printed board is joined with the second terminal of the suspension tail unit by soldering.

### (Manufacturing Method)

The present invention provides a manufacturing method of an electronic device having a solder joint structure not using flux.

The manufacturing method of the electronic device according to the present invention including

a first step of having a first terminal unit having a plurality of first terminal conductors arranged on a first insulating layer, a cover layer coating both ends of a surface of the first terminal conductor, and a solder bump precoating an exposed surface of the first terminal conductor and fixing and disposing the first terminal unit at an operation position;

a second step of having a second terminal unit having a plurality of second terminal conductors, which are arranged on a second insulating layer so as to be opposed to the first terminal conductors and have a solder joint observation window through which a solder joint state can be visually checked from outside via the second insulating layer, and an Au plating layer plated on a surface of the second terminal conductor and positioning the second terminal conductor of the second terminal unit to an operation position opposed to the first terminal conductor of the first terminal unit;

a third step of carrying out heating and melting while the second terminal conductor of the second terminal unit is pressed against the solder bump of the first terminal unit so as to join the first terminal conductor with the second terminal conductor by soldering without using flux; and

a fourth step of observing and examining the solder joint state by the solder bump from outside via the second insulating layer according to the solder joint observation window of the second terminal conductor.

According to the present invention, when the second terminal conductor on which the Au plating layer of the second terminal is formed is pressed against and heated with the solder bump precoating the first terminal conductor of the first terminal so as to carry out melting and joint, solder enters the solder joint observation window formed in the second terminal conductor as a notch or a slit so as to form a fillet, the formation state of the solder fillet with respect to the solder joint observation window of the second terminal conductor can be checked from outside via the second insulating layer in an examination step after the solder joint, the joint by an appropriate solder amount that does not protrudes from the second terminal conductor to the outside and has been conventionally considered as an appearance defective product since no protruding part is confirmed can be correctly determined as an appearance non-defective product, and the manufacturing yield can be improved by improving the appearance examination performance.

The solder enters the notch or a slit formed in the second terminal conductor as a solder joint observation window and forms the solder fillet; therefore, three-dimensional joint is added to the conventional joint, which is two dimensional joint of solder with respect to the terminal surface, by the joint by the formation of the solder fillet with respect to the notch or the slit, the joint strength in the exfoliation direction orthogonal to the joint surfaces is improved in addition to the joint strength in the joint surface direction, and joint quality and durability at a location such as a rotary actuator of a magnetic disk where it undergoes vibrations, and the like can be further improved.

Furthermore, by forming the notch, slit, or the like as the solder joint observation window in the second terminal conductor, the conventional control of increasing the solder amount of the solder bump so that the solder protrudes from the terminal conductor becomes unnecessary, short circuit with an adjacent terminal can be reliably prevented, and the permissible distance of alignment of terminal positioning can be increased; as a result, significant reduction in the cost of terminal constituent members and manufacturing equipment can be expected. The above and other objects, features, and advantages of the present invention will become more apparent from the following detailed description with reference to the drawings.

### BRIEF DESCRIPTION OF THE DRAWINGS

FIGS. 1A and 1B are explanatory drawings showing a solder protruding state in which appearance non-defective product is determined in conventional fluxless solder joint;

FIGS. 2A and 2B are explanatory drawings showing the state without solder protrusion in which appearance defective product is determined in conventional fluxless solder joint;

FIG. 3 is an explanatory drawing showing an inner structure of a magnetic disk apparatus to which the present invention is applied;

FIG. 4 is an explanatory drawing showing the rotary actuator of FIG. 3 in an extracted and partially omitted state;

FIGS. 5A and 5B are explanatory drawings extracting the FPC of FIG. 4 and showing it together with an enlarged part of a FPC terminal unit;

FIG. 6 is a cross sectional drawing showing the X-X cross section of the FPC terminal unit of FIG. 4;

FIGS. 7A and 7B are explanatory drawings extracting and showing the head gimbal assembly of FIG. 4;

FIG. 8 is an explanatory drawing showing the suspension terminal conductor of FIGS. 7A and 7B in an enlarged manner;

FIG. 9 is an explanatory drawing showing the suspension terminal unit of FIGS. 7A and 7B in an enlarged manner;

FIG. 10 is an explanatory drawing showing the positional alignment of the suspension terminal conductor of FIG. 9 and the FPC terminal conductor of FIGS. 5A and 5B;

FIG. 11 is a cross sectional drawing showing the Y-Y cross section of the suspension terminal unit of FIG. 8;

FIG. 12 is an explanatory drawing in which the suspension terminal unit is positioned and overlapped with the FPC terminal unit;

FIGS. 13A to 13C are explanatory drawings showing operation steps of subjecting the suspension terminal unit to solder joining with the FPC terminal unit without using flux;

FIG. 14 is an explanatory drawing showing an examination step of subjecting the terminal unit, which has undergone solder joining by the operation steps of FIGS. 13A to 13C, to appearance examination;

FIG. 15 is an explanatory drawing showing the formation state of solder fillets in notches formed in suspension terminal conductors observed in the appearance examination of FIG. 14;

FIG. 16 is an explanatory drawing showing another embodiment of the suspension terminal conductor in which triangular notches are formed as solder joint observation windows;

FIG. 17 is an explanatory drawing showing another embodiment of the suspension terminal conductor in which semicircular notches are formed as solder joint observation windows;

FIG. 18 is an explanatory drawing showing another embodiment of the suspension terminal conductor in which an oval slit is formed as solder joint observation window;

FIG. 19 is an explanatory drawing showing another embodiment of the suspension terminal conductor in which a rectangular slit is formed as solder joint observation window;

FIG. 20 is an explanatory drawing showing another embodiment of the suspension terminal conductor in which rectangular notches and an oval slit are formed as solder joint observation windows;

FIG. 21 is an explanatory drawing showing another embodiment of the suspension terminal conductor in which wave-shape edges are formed as solder joint observation windows;

FIG. 22 is an explanatory drawing showing another embodiment of the suspension terminal conductor in which wave-shape edges and an oval slit are formed as solder joint observation windows;

FIG. 23 is an explanatory drawing showing another embodiment of the suspension terminal conductor in which comb tooth edges are formed as solder joint observation windows;

FIG. 24 is an explanatory drawing showing another embodiment of the suspension terminal conductor in which comb tooth edges and a rectangular slit are formed as solder joint observation windows;

FIG. 25 is an explanatory drawing showing another embodiment of the suspension terminal conductor in which a plurality of circular slits are formed as solder joint observation windows;

FIG. 26 is an explanatory drawing showing another embodiment of the suspension terminal conductor in which wave-shape edges and a plurality of circular slits are formed as solder joint observation windows;

FIG. 27 is an explanatory drawing showing another embodiment of the suspension terminal conductor in which comb tooth edges and a plurality of circular slits are formed as solder joint observation windows; and

FIGS. 28A and 28B are explanatory drawings showing another embodiment in which notches serving as solder observation windows are formed at four locations of the outer periphery of a circular suspension terminal conductor.

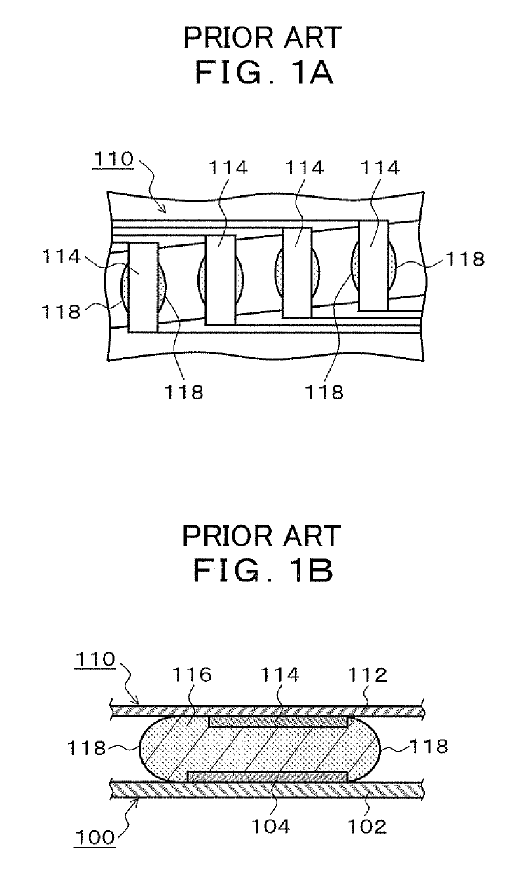

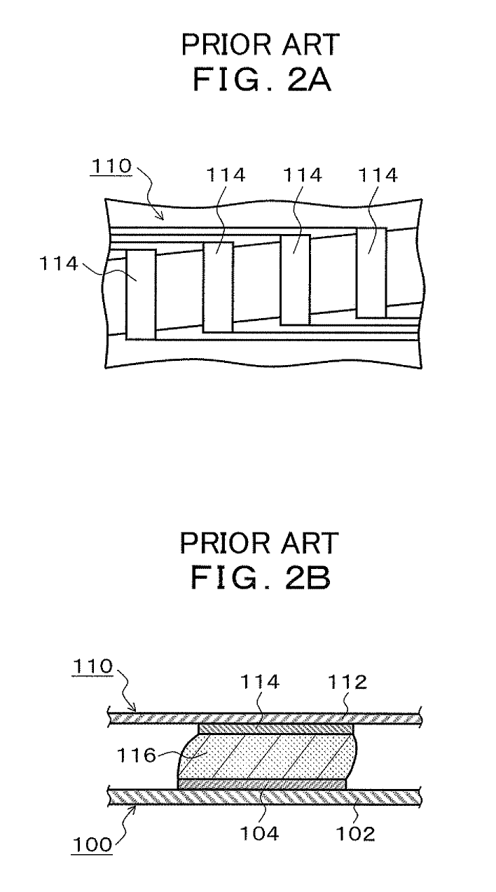

### DETAILED DESCRIPTION OF THE PREFERRED EMBODIMENTS

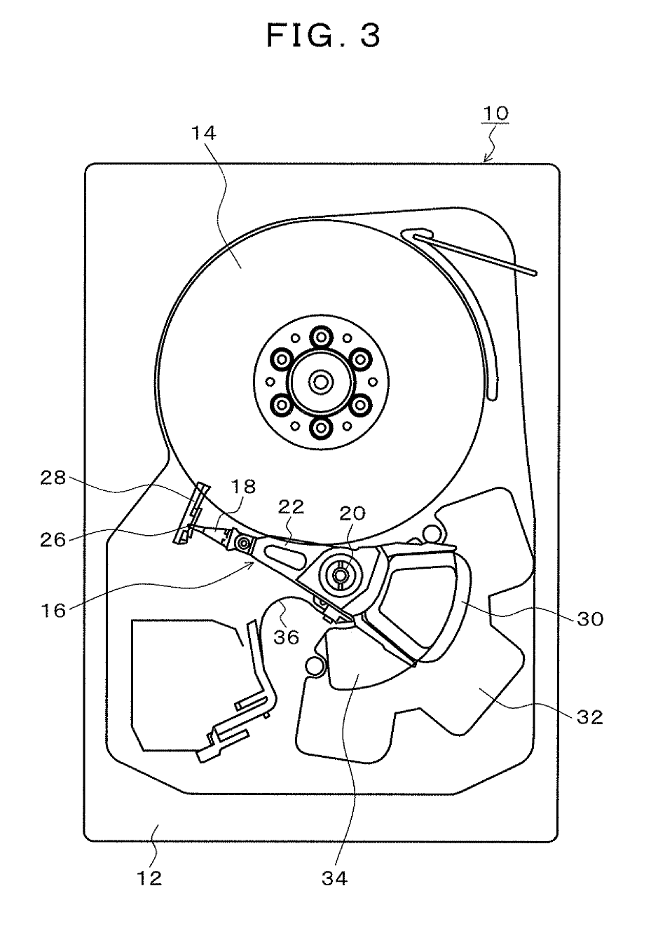

FIG. 3 is an explanatory drawing which takes a magnetic disk apparatus as an example and shows, as an electronic device of the present invention, an inner structure of a chassis base side by removing a chassis cover. In FIG. 3, in the magnetic disk apparatus 10, a magnetic disk 14 which is rotated at a constant speed by a spindle motor is provided in the chassis base 12. With respect to the magnetic disk 14, a rotary actuator 16 is provided. The rotary actuator 16 is rotatably supported by a shaft unit 20 with respect to the chassis base 12, a head gimbal assembly 18 is attached to the distal end side thereof via an arm 22 so as to support a head 26, and a coil 30 is attached to the rear end side thereof. In the coil 30 side of the rotary actuator 16, a magnetic circuit unit which is fixed to the chassis base 12 is provided, and the coil 30 and the magnetic circuit unit constitute a voice coil motor which drives the rotary actuator 16. In the magnetic circuit unit in the chassis base 12 side, a magnet 34 is disposed above a lower yoke 32 which is fixed to the chassis base 12, and the magnet 34 has a shape covering the turning range of the coil 30 by the rotary actuator 16. Above the magnet 34, the coil 30 at the rear part of the rotary actuator 16 is positioned so as to be rotatable about the shaft unit 20; and, although an upper yoke which is opposed to the lower yoke 32 and has the same shape is disposed above the coil 30, FIG. 3 is shown in the state in which the upper yoke is removed and omitted. A flexible printed board (hereinafter, referred to as “FPC”) 36 is lead out from a side surface of the rotary actuator 16 to a circuit mounting unit of a fixed side. In the FPC 36, a signal line for the head 26 and for the coil 30 are formed as a flexible print pattern, a head IC having a write driver and a preamplifier which perform signal processing with respect to a recording element and a reading element of the head 26 is mounted, and it carries out transmission of, for example, control signals, write signals, read signals, and the like with an unshown control board which is disposed in the chassis base 12 side.

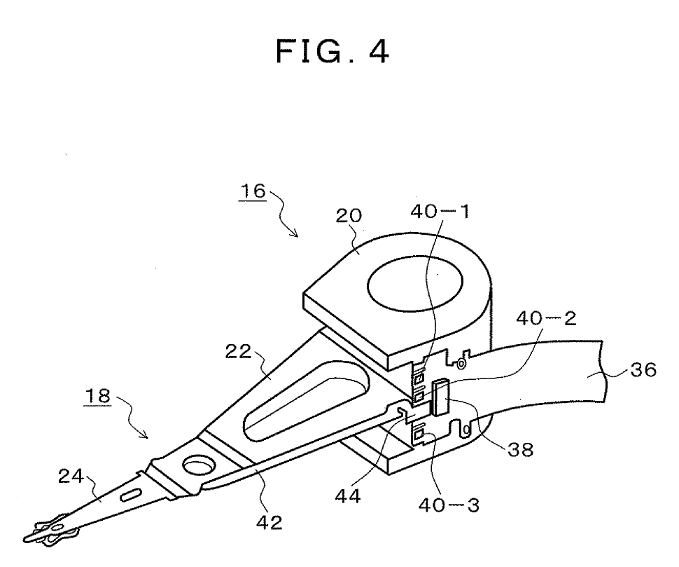

FIG. 4 is an explanatory drawing extracting the rotary actuator of FIG. 3 and showing it in a partially omitted state. In FIG. 4, in the rotary actuator 16, the head gimbal assembly 18 is fixed by caulking to the arm 22 extending from the shaft unit 20, and the head gimbal assembly 18 is composed of a suspension attachment arm 24 and a long tail suspension 42. The distal end side of the long tail suspension 42 is disposed below the suspension attachment arm 24, the head 26 having a recording element, a reading element, and a slider is supported at the distal end thereof, the rear end thereof is attached to a side surface of the arm 22, and a suspension terminal unit 44 for establishing electric connection to the FPC 36 supported by and fixed to the side surface of the shaft unit 20 of the rotary actuator 16 is provided. One end of the FPC 36 is fixed to a side surface of the shaft unit 20 of the rotary actuator 16, a head IC 38 is mounted thereon, and FPC terminal units 40-1 to 40-4 for electrically connecting the suspension terminal unit 44 of the long tail suspension 42 provided in the head gimbal assembly 18 are formed thereon. The FPC terminal units 40-1 to 40-4 provided on the FPC 36 constitute a first terminal unit of the present invention, and the suspension terminal unit 44 provided in the long tail suspension 42 constitutes a second terminal unit of the present invention.

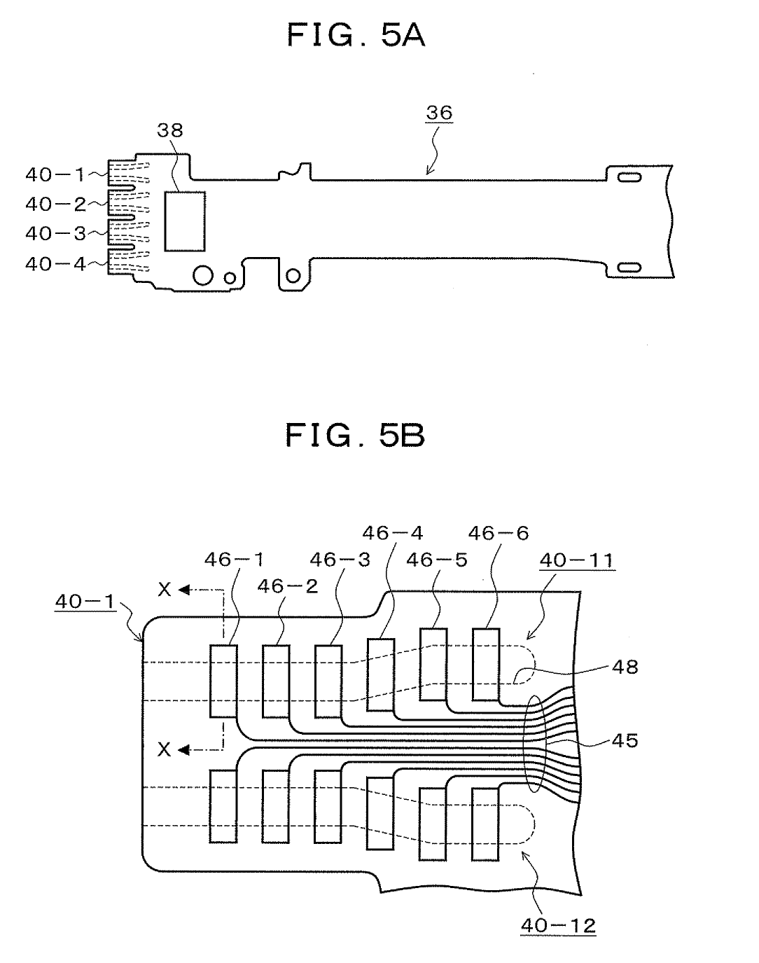

FIGS. 5A and 5B are explanatory drawings extracting the FPC 36 of FIG. 4 and showing it together with an enlarged part of the FPC terminal unit. FIG. 5A shows the rotary actuator side of the FPC 36, wherein the FPC terminal units 40-1 to 40-4 constituting the first terminal unit are formed at a distal end of the FPC 36, and the head IC 38 is mounted behind it. In the FPC 36, a Cu pattern constituting a circuit and lines is formed on a flexible base film, and non-connecting part of the Cu pattern is coated with a cover film.

FIG. 5B enlarges and shows the FPC terminal unit 40-1 of FIG. 5A. In the FPC terminal unit 40-1, two FPC terminal units 40-11 and 40-12 are provided in the present embodiment. As shown about the FPC terminal unit 40-11 among these, in the present embodiment, six rectangular FPC terminal conductors 46-1 to 46-6 are arranged at constant intervals. With respect to the FPC terminal conductors 46-1 to 46-6, a cover film opening 48 shown by a broken line is positioned, and the conductive surfaces of the FPC terminal conductors 46-1 to 46-6 are exposed to outside at the part of the cover film opening 48. A wiring pattern is lead out from each of the FPC terminal conductors 46-1 to 46-6, and they are lead to the chassis base side as a wiring pattern group 45.

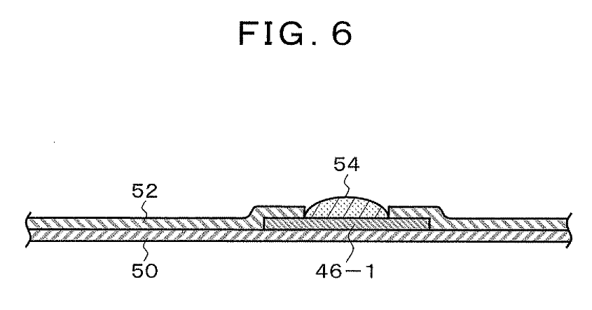

FIG. 6 is a cross sectional drawing showing the X-X cross section of FIG. 5B. In the FPC terminal unit, as shown in the cross sectional structure thereof, the FPC terminal conductor 46-1 and a wiring pattern, which is not shown, continued therefrom are formed by Cu plating or the like on a flexible film layer 50, and a cover film layer 52 is formed except for the connecting part of the FPC terminal conductor 46-1. The exposed part of the FPC terminal conductor 46-1 is precoated with a solder bump 54. The solder bump 54 precoating the FPC terminal conductor 46-1 is controlled so that the amount of solder is sufficient for the solder connection with the suspension terminal unit 44 of the long tail suspension 42 side shown in FIG. 4 not using flux.

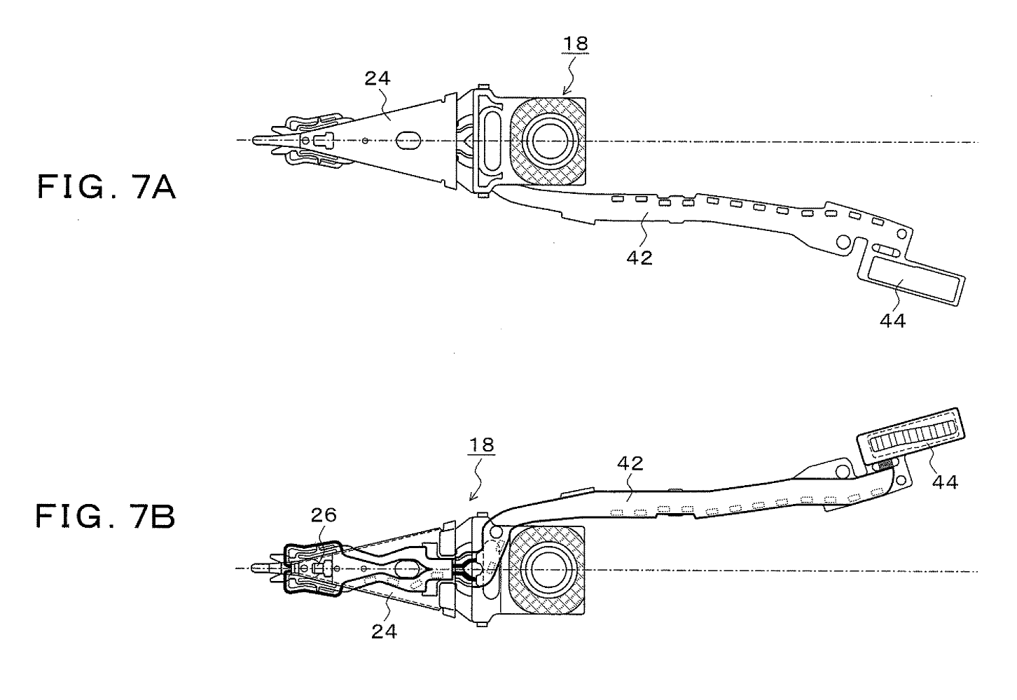

FIGS. 7A and 7B are explanatory drawings extracting and showing the head gimbal assembly of FIG. 4. FIG. 7A is a plan view of the head gimbal assembly 18, and FIG. 7B shows a back view showing the back side. The head gimbal assembly 18 fixes the long tail suspension 42 to the back surface side of the suspension attachment arm 24 by bonding or the like. The head 26 is attached to the distal end of the long tail suspension 42, the suspension terminal unit 44 is formed in the tail side thereof, and the part therebetween is connected by a circuit pattern. In other words, the long tail suspension 42 functions to electrically connect the head 26 with the head IC 38 of the FPC 36 shown in FIG. 4. The transmission path on the long tail suspension 42 is manufactured by coating the upper side of, for example, stainless steel foil serving as metal foil with an insulating layer, then forming a circuit layer by Cu plating or the like, further forming a protective layer in the circuit layers, and carrying out edging of the stainless steel layer, and it is formed as a thin film circuit according to a semiconductor manufacturing process.

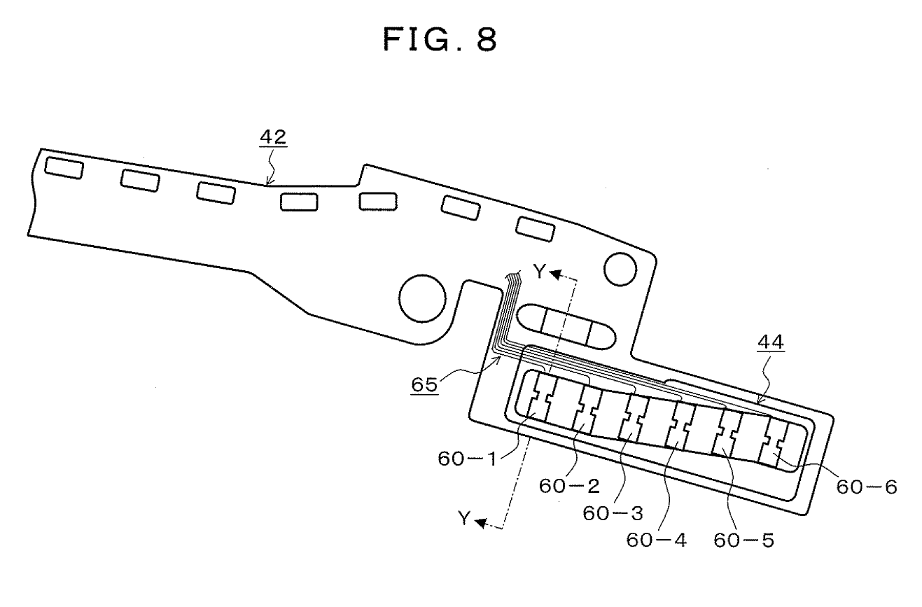

FIG. 8 is an explanatory drawing showing the suspension terminal unit of the long tail suspension of FIGS. 7A and 7B in an enlarged manner. In FIG. 8, at an end of the tail side of the long tail suspension 42, the suspension terminal unit 44 constituting the second terminal unit of the present invention is provided. In the suspension terminal unit 44, suspension terminal conductors 60-1 to 60-6 are arranged at predetermined intervals, and a wiring pattern 65 is lead out from the suspension terminal conductors 60-1 to 60-6 and connected to the head 26 shown in FIGS. 7A and 7B. Moreover, with respect to the wiring pattern 65, a protective layer is provided except for the exposed part of the suspension terminal conductors 60-1 to 60-6. Since a heater element for controlling the head flying distance by utilizing thermal expansion is further provided in the head 26 shown in FIGS. 7A and 7B in addition to the recording element and the reading element, in the long tail suspension 42 of the present embodiment, six suspension terminal conductors 60-1 to 60-6 are provided since two wiring patterns are required for each of the recording element, the reading element and the heater element. Note that, when merely the recording element and the reading element are provided without the heater element as the head 26, four suspension terminal conductors of the suspension terminal unit 44 are required to be arranged.

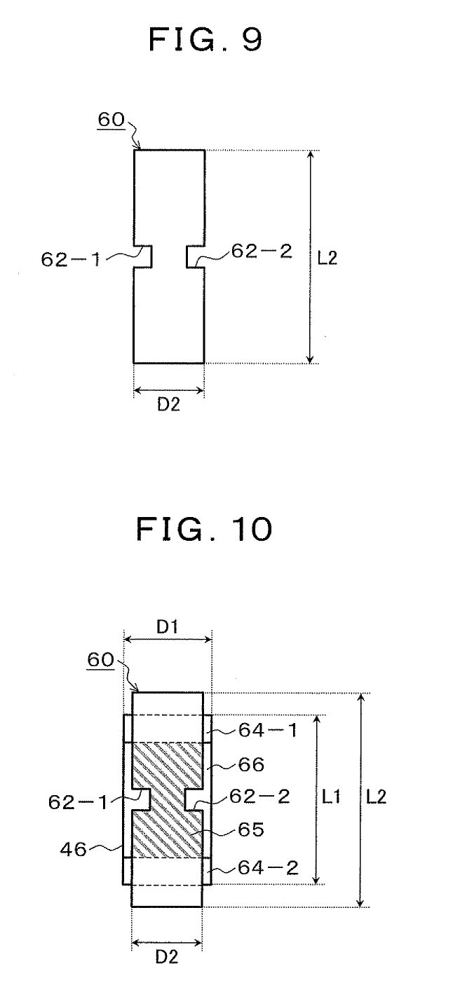

FIG. 9 is an explanatory drawing showing the suspension terminal conductor of FIG. 8 in an enlarged manner. In FIG. 9, the suspension terminal conductor 60 is a rectangular conductor having a width of D2 and a height of L2, and rectangular notches 62-1 and 62-2 which function as solder joint observation windows are formed at two locations approximately at the center of the sides of the longitudinal direction.

FIG. 10 is an explanatory drawing showing the positional alignment of the case in which the suspension terminal conductor 60 of FIG. 9 and the FPC terminal conductor 46 shown in FIGS. 5A and 5B are overlapped with each other for solder joint. In FIG. 10, in solder joint according to the present embodiment not using flux, in the state in which the FPC terminal conductor 46 is fixed and disposed, the suspension terminal conductor 60 is positioned as shown in the drawing, and the solder joint is carried out. Herein, in the FPC terminal conductor 46 side, cover parts 64-1 and 64-2 wherein cover films are positioned are formed at both sides. The FPC terminal conductor 46 has a height of L1 and a width of D1, wherein the height L1 is smaller than the height L2 of the suspension terminal conductor 60, and the width D1 is larger than the width D2 of the suspension terminal conductor 60. For example, the width D1 of the FPC terminal conductor 46 is D1=0.26 mm, meanwhile, the width D2 of the suspension terminal conductor 60 is, for example, D2=0.24 mm; therefore, a positioning margin ΔD in the lateral direction is ΔD=D1−D2=0.26−0.24=0.02 mm. Regarding the positional alignment of the FPC terminal conductor 46 and the suspension terminal conductor 60 having the dimensions of such widths and heights, the suspension terminal conductor 60 is positioned so as to be centered in the lateral direction and the height direction with respect to the exposed part 66 of the fixed and disposed FPC terminal conductor 46, thereby achieving the state in which an overlapping part 65 shown by oblique lines is ensured with respect to the suspension terminal conductor 60, and, in this state, solder joint is carried out.

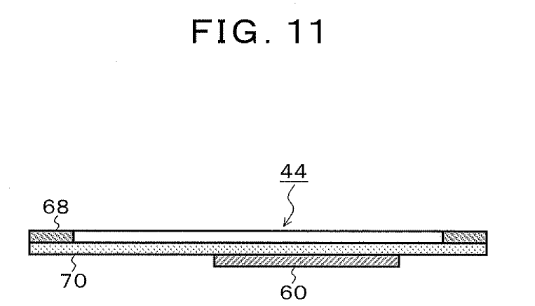

FIG. 11 is a cross sectional drawing showing the Y-Y cross section of the suspension terminal unit of FIG. 8. In FIG. 11, the suspension terminal unit 44 has an insulating layer 70 using polyimide supported by stainless-steel foil 68, the suspension terminal conductor 60 is formed by Cu plating on the insulating layer 70, and, furthermore, an Au plating layer is formed by Au plating processing on the suspension terminal conductor 60.

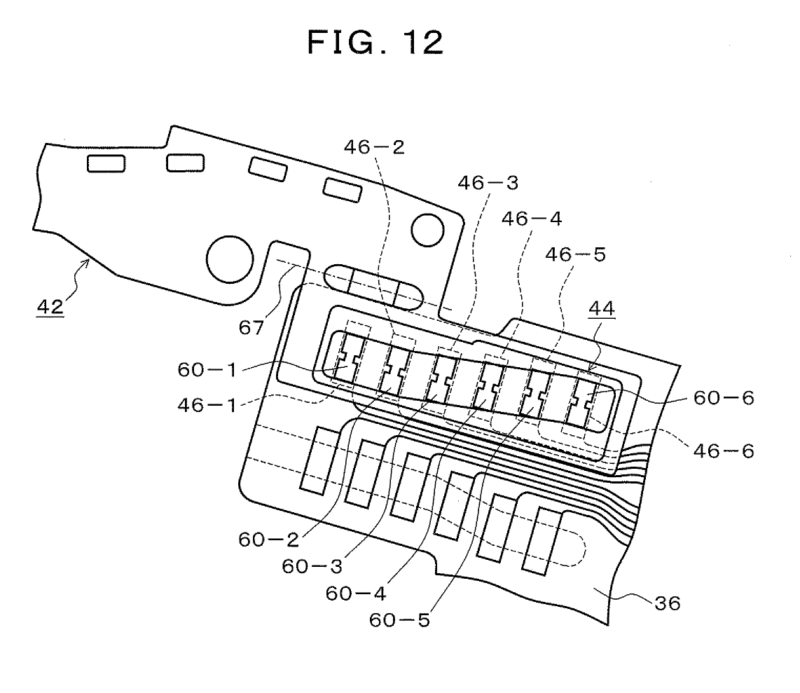

FIG. 12 is an explanatory drawing in which the suspension terminal unit is positioned and overlapped with the FPC terminal of the present embodiment. In FIG. 12, the FPC 36 is fixed to the side surface of the shaft unit 20 of the rotary actuator 16 as shown in FIG. 4; with respect to the FPC terminal unit 40 thereof, the suspension terminal unit 44 of the long tail suspension 42 provided in the head gimbal assembly 18 is overlapped from above, so that the suspension terminal conductors 60-1 to 60-6 are overlapped with the FPC terminal conductors 46-1 to 46-6; and, at this point, both of them are positioned so as to have the positional alignment as shown in FIG. 10. Note that, in actual solder joint, the suspension terminal unit 44 of the long tail suspension 42 is positioned at the terminal unit of the FPC 36 as shown in FIG. 4 in the state in which the suspension terminal unit 44 is bent at a right angle from a bending line 67 at a coupling part thereof.

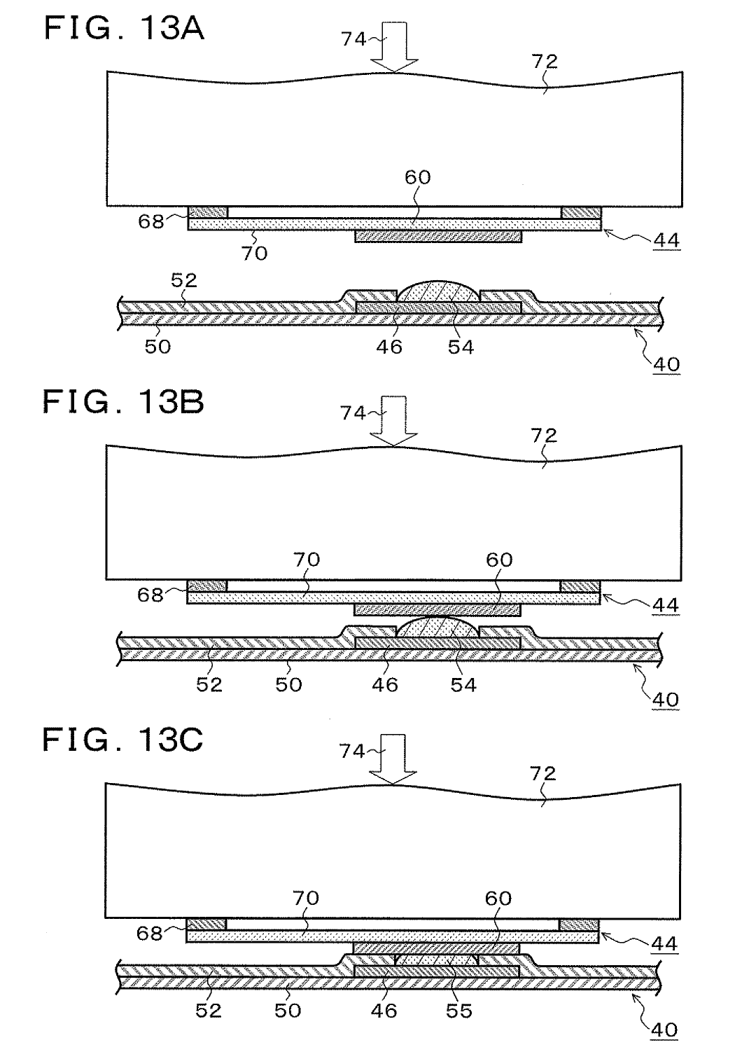

FIGS. 13A to 13C are explanatory drawings showing operation steps of joining the FPC terminal unit with the suspension terminal unit by soldering without using flux according to the present embodiment.

FIG. 13A shows a positioning state before solder joint. First of all, the FPC terminal 40 side is positioned and disposed in the fixed side of solder joint equipment, and, in this state, the suspension terminal conductor 60 is positioned so that the suspension terminal unit 44 side is opposed to the FPC terminal conductor 46 of the FPC terminal unit 40, which is fixed and disposed. Subsequently, a heater chip 72 is pressed against the suspension terminal unit 44 from outside, and pressurizing force 74 is applied thereto so as to move it to the FPC terminal unit 40 side.

FIG. 13B shows the state in which the conductive surface of the suspension terminal conductor 60 of the suspension terminal unit 44 is brought into contact with the solder bump 54 precoating the FPC terminal conductor 46 of the FPC terminal unit 40 by the pressurizing movement of the heater chip 72. In this state, heat is applied to the solder bump 54 via the suspension terminal unit 44 by the heater chip 72. When the solder bump 54 melts by heating by the heater chip 72, the suspension terminal unit 44 sinks as shown in FIGS. 13A to 13C by the pressurizing force 74, and, at the same time, Au plated on the suspension terminal conductor 60 diffuses to the solder 55 and undergoes solder joint with, for example, Cu or Ni which is a metal in the solder 55. The sunk suspension terminal conductor 60 pressed by the pressurizing force 74 upon solder melting abuts the cover film layer 52 provided in the FPC terminal unit 40 side and is not forced thereinto more than that; therefore, the solder 55 is not excessively crushed, and the short circuit with an adjacent terminal conductor caused by leakage of the solder 55 in the lateral direction does not occur. Controlling the solder amount of the solder bump 54 is important in such solder joint operations of FIGS. 13A to 13C not using flux. As the solder mount of the solder bump 54, a solder amount sufficient for the solder to be wet and spread to the suspension terminal conductor 60 upon solder joint is required, and the solder amount of the solder bump 54 has to be controlled so that the solder amount does not cause the solder to leak in the lateral direction when it is pressed and crushed so that short circuit with an adjacent terminal conductor does not occur.

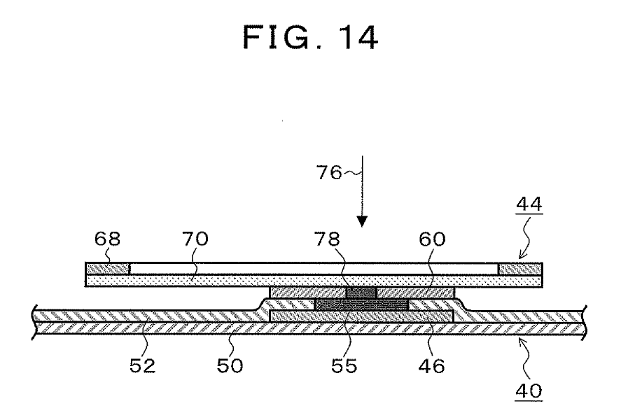

FIG. 14 is an explanatory drawing showing an examination step of carrying out appearance examination of the terminal units which have undergone solder joint by the operation steps of FIGS. 13A to 13C. In FIG. 14, with respect to the terminal units which have undergone solder joint, the solder joint state of the suspension terminal unit 44 and the FPC terminal unit 40 is observed in the direction shown by an appearance examination direction 76, that is, from outside the suspension terminal unit 44, thereby carrying out examination. At this point, in the present embodiment, the rectangular notches 62-1 and 62-2, which function as solder joint observation windows, are formed approximately at the center of the long sides of the rectangle of the suspension terminal conductor 60 as is extracted and shown in FIG. 9; therefore, as is shown about the suspension terminal conductor 60 of which side surfaces are shown in FIG. 14, the solder 55 enters the rectangular notches formed in the side surfaces of the suspension terminal conductor 60, thereby forming solder fillets 78. Therefore, in the examination step, when how the solder fillets 78 appear in the rectangular notch parts of the suspension terminal conductor 60 is viewed via the insulating layer 70 of the suspension terminal unit 44 in the appearance examination direction 76, whether it is an appearance non-defective product or an appearance defective product can be appropriately determined.

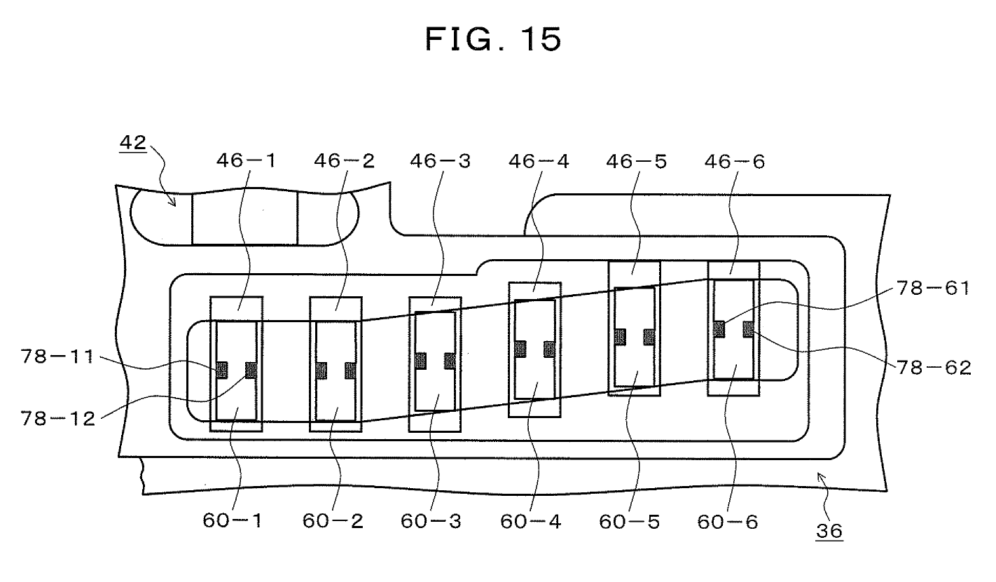

FIG. 15 is an explanatory drawing showing the formation state of the solder fillets in the notches formed in the suspension terminal conductor observed in the appearance examination of FIG. 14. In FIG. 15, regarding the suspension terminal conductors 60-1 to 60-6 provided in the suspension terminal unit 44 of the long tail suspension 42 side, the state of solder fillets 78-11, 78-12 to 78-61, and 78-62 caused by entering of the solder with respect to the notches formed in the suspension terminal conductors 60-1 to 60-6 can be observed by visual check in a transparent manner via the insulating layer 70 above them. When the solder fillets 78-11 to 78-62 are sufficiently observed as shown in the drawing with respect to the rectangular notches, it can be confirmed that the solder crushing state is appropriate and the solder joint between the suspension terminal conductors 60-1 to 60-6 and the FPC terminal conductors 46-1 to 46-6 is carried out well. On the other hand, when the state of the solder fillets 78-11 to 78-62 does not appear in the rectangular notches and cannot be checked, the solder amount is deficient or the solder is not sufficiently crushed due to insufficient pressurizing upon solder joint; therefore, it can be determined to be an appearance defective product. When merely small portions of the solder fillets 78-11 to 78-62 appear inside the rectangular notches, similarly, the solder amount is deficient or pressing for crushing the solder is insufficient; therefore, it is determined to be an appearance defective product also in this case. The appearance defective product can be determined to be an appearance non-defective product or an appearance defective product depending on whether the solder fillets can be sufficiently checked when pressurizing and heating by the heater chip 72 is performed again as shown in FIGS. 13B and 13C and examination is carried out again. Furthermore, when the solder fillets 78-11 to 78-62 protrude from the rectangular notches to the outside in the appearance examination of FIG. 15, the solder amount of the solder fillets is too much; therefore, a countermeasure of controlling the solder amount is taken so that it is reduced to an appropriate amount. Furthermore, as is clear from the solder joint of the terminal units of FIG. 14, in the present embodiment, the solder 55 formed by the solder joint enters the part of the rectangular notch formed in the suspension terminal conductor 60, thereby forming the solder fillet 78; and, by virtue of the entering of the solder forming the solder fillet 78, the suspension terminal conductor 60 can be jointed in the thickness direction orthogonal to the conductive surface. Therefore, three-dimensional solder joint is realized when the joint by the formation of the solder fillet 78 is added; and, corresponding to the amount the solder joint by the solder fillet 78 is added, the strength of the solder joint is enhanced, and long-term reliability and durability of the case in which it is used in a location such as a rotary actuator where vibrations are applied can be improved.

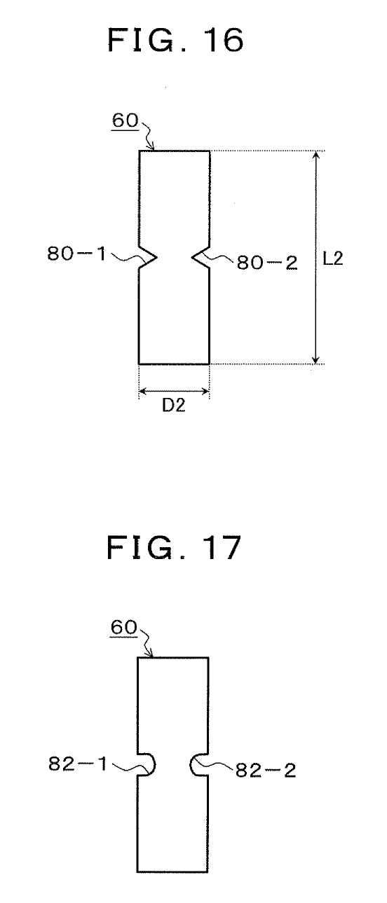

FIG. 16 is an explanatory drawing showing another embodiment of the suspension terminal conductor in the present invention; and, although the point that the suspension terminal conductor 60 has a rectangular shape having the width D2 and the height L2 is same as the embodiment of FIG. 9, this embodiment has a characteristic that triangular notches 80-1 and 80-2 which function as solder joint observation windows are provided in both sides in the longitudinal direction. Also in this embodiment of FIG. 16, the triangular notches 80-1 and 80-2 are provided without changing the terminal width D2; therefore, the overlapping amount upon overlapping with the FPC terminal can be appropriately ensured, whether it is an appearance non-defective product or an appearance defective product can be appropriately determined from the state of solder fillets with respect to the triangular notches 80-1 and 80-2 upon appearance examination after solder joining, and, furthermore, the joint strength can be also enhanced by the joint of the solder fillets with respect to the triangular notches 80-1 and 80-2.

FIG. 17 is an explanatory drawing showing another embodiment of the suspension terminal conductor according to the present invention, and this embodiment has a characteristic that semicircular notches 82-1 and 82-2 which function as solder joint observation windows are provided in both sides in the longitudinal direction of the rectangular suspension terminal conductor 60 having the width D2 and the height L2. Also in this embodiment of FIG. 17, the semicircular notches 82-1 and 82-2 are formed without changing the terminal width D2; therefore, the overlapping amount to be overlapped with the FPC terminal can be ensured, whether it is an appearance non-defective product or an appearance defective product can be appropriately determined from the state of the solder fillets with respect to the semicircular notches 82-1 and 82-2 in the appearance examination after solder joint, and, furthermore, formation of the solder fillets with respect to the semicircular notches 82-1 and 82-2 enhances the joint strength.

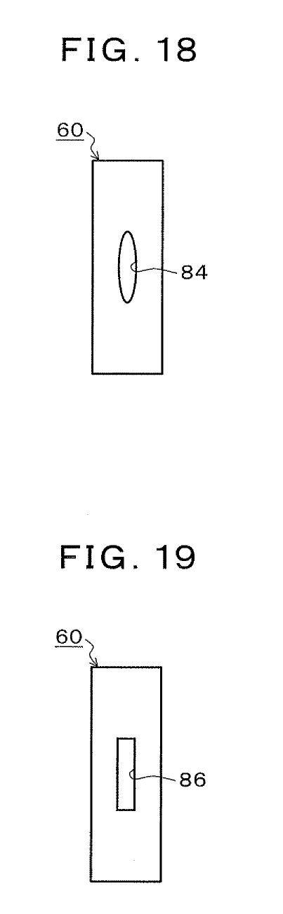

FIG. 18 is an explanatory drawing showing another embodiment of the suspension terminal conductor according to the present invention, and this embodiment has a characteristic that an oval slit 84 which functions as a solder joint observation window is bored at the center of the rectangular suspension terminal conductor 60 having the terminal width D2 and the height L2. Also in this embodiment, the oval slit 84 is formed without changing the width and the height of the suspension terminal conductor 60; therefore, the overlapping amount to be overlapped with the FPC terminal can be ensured, whether it is an appearance non-defective product or an appearance defective product can be determined by viewing the solder fillet with respect to the oval slit 84 in the appearance examination after the solder joint, and, furthermore, formation of the solder fillet with respect to the oval slit 84 also enhances the joint strength.

FIG. 19 is an explanatory drawing showing another embodiment of the suspension terminal conductor according to the present invention, and this embodiment has a characteristic that a rectangular slit 86 is provided a the center of the suspension terminal conductor 60 having the width D2 and the height L2. As a result of providing the rectangular slit 86 in the suspension terminal conductor 60 in this manner, a solder fillet is formed in the rectangular slit 86 by solder joint, whether it is an appearance non-defective product or an appearance defective product can be appropriately determined by checking the solder fillet in appearance examination, and formation of the solder fillet can also improve the joint strength.

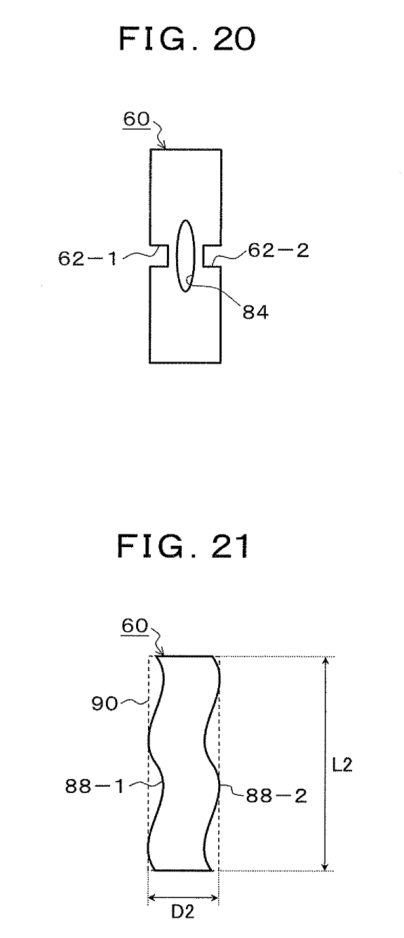

FIG. 20 is an explanatory drawing showing another embodiment of the suspension terminal conductor according to the present invention, and this embodiment has a characteristic that the rectangular notches 62-1 and 62-2 are provided in both sides in the longitudinal direction of the suspension terminal conductor 60 having the width D2 and the height L2, and the oval slit 84 is provided at the center thereof. In other words, this embodiment can be considered as a combination embodiment of the embodiment of FIG. 9 and FIG. 18. As a result of providing the rectangular notches 62-1 and 62-2 and the oval slit 84 in the suspension terminal conductor 60, in the appearance examination after the solder joint is carried out, whether it is an appearance non-defective product or an appearance defective product can be appropriately determined by observing the formation state of the solder fillet of each of the oval slit 84 and the rectangular notches 62-1 and 62-2. More specifically, regarding the appearance non-defective product, when a solder fillet appears in the oval slit 84, and sufficient solder fillets appear from inside to outside with respect to the rectangular notches 62-1 and 62-2, it can be determined as the appearance non-defective product. When no solder fillet is in the rectangular notches 62-1 and 62-2 although a solder fillet is formed in the oval slit 84, it is determined to be a non-defective product in the appearance examination of the case of FIG. 18 of merely the oval slit 84; therefore, it is determined to be an appearance non-defective product in this case. On the other hand, when no solder fillet is observed in the rectangular notches 62-1 and 62-2, and no solder fillet is observed also in the oval slit 84 or a solder fillet is observed merely in part thereof, it can be determined to be an appearance defective product.

FIG. 21 is an explanatory drawing showing another embodiment of the suspension terminal conductor according to the present invention, and this embodiment has a characteristic that solder observation windows are formed by forming the both sides in the longitudinal direction of the suspension terminal conductor 60 into wave-shape edges 88-1 and 88-2. In the suspension terminal conductor 60 in which the wave-shape edges 88-1 and 88-2 are formed, a basic outline shape 90 shown by broken lines connecting the four corners thereof has the width D2 and the height L2 and is matched with the original conductor shape, and the wave-shape edges 88-1 and 88-2 are formed in the longitudinal direction within the range of the basic outline shape 90. Therefore, the positional alignment upon positioning of the suspension terminal conductor 60 with the FPC terminal conductor and the overlapping amount in the positioned state can be appropriately ensured. In the appearance examination after the suspension terminal conductor 60 is joined with the FPC terminal conductor by soldering, whether it is an appearance non-defective product or an appearance defective product can be determined by viewing the solder fillets formed in the concave parts of the wave-shape edges 88-1 and 88-2. More specifically, when the solder fillets are formed in the entirety of the concave parts of the wave-shape edges 88-1 and 88-2, it can be determined to be an appearance non-defective product, and it can be determined to be an appearance defective product when no solder fillet is formed in the concave parts.

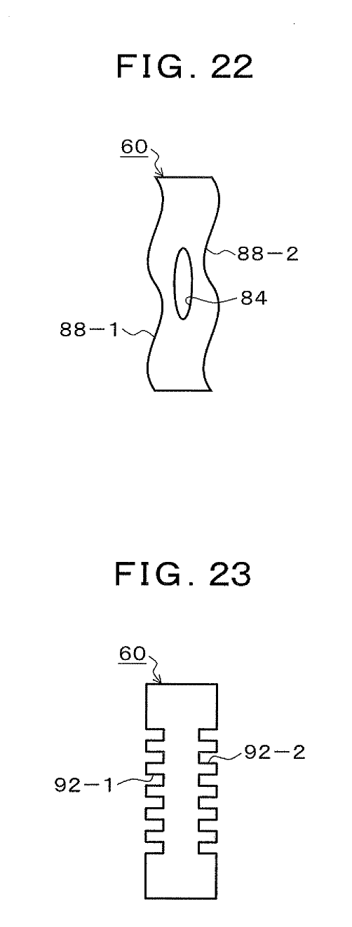

FIG. 22 is an explanatory drawing showing another embodiment of the suspension terminal conductor according to the present invention, and the suspension terminal conductor 60 of this embodiment has a characteristic that the wave-shape edges 88-1 and 88-2 are formed in both sides in the longitudinal direction of the terminal conductor having a rectangular shape, and, at the same time, the oval slit 84 is bored at the center. In other words, the embodiment of FIG. 22 can be considered as a combination embodiment of the embodiment of FIG. 18 and FIG. 21. Also in the suspension terminal conductor 60 of the embodiment of FIG. 22, in the appearance examination after the solder joint with the FPC terminal, whether it is an appearance non-defective product or an appearance defective product can be determined by viewing the solder fillet which appears in the oval slit 84 in addition to the concave parts of the wave-shape edges 88-1 and 88-2. Moreover, the joint strength can be improved by forming the solder fillets with respect to the wave-shape edges 88-1 and 88-2 and the oval slit 84.

FIG. 23 is an explanatory drawing showing another embodiment of the suspension terminal conductor according to the present embodiment, and the suspension terminal conductor 60 of this embodiment has a characteristic that comb tooth edges 92-1 and 92-2 are formed in both sides in the longitudinal direction of the rectangular suspension terminal conductor 60 having the width D2 and the height L2. With respect to the suspension terminal conductor 60 in which such comb tooth edges 92-1 and 92-2 are formed, in the appearance examination after it is joined with the FPC terminal conductor by soldering, whether it is an appearance non-defective product or an appearance defective product can be appropriately determined by observing the state of the solder fillets with respect to the incision portions of the comb tooth edges 92. Moreover, the joint strength can be improved by forming the solder fillets in the comb tooth edges 92-1 and 92-2. Particularly, by virtue of formation of the comb tooth edges 92-1 and 92-2, the solder fillet formed part into which solder enters in the thickness direction is increased; as a result, the joint strength in the thickness direction can be considerably enhanced.

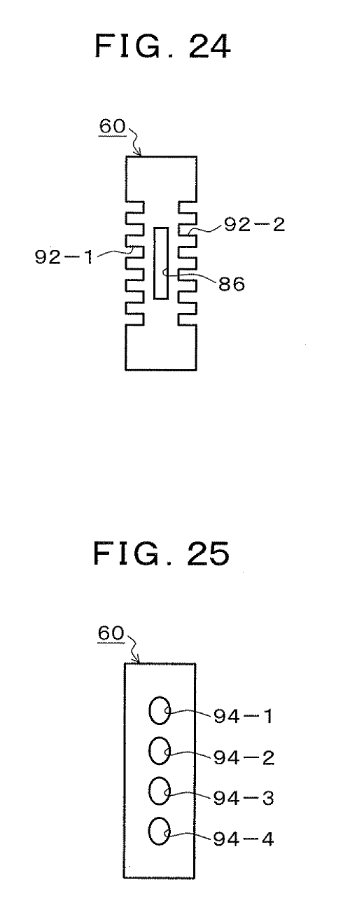

FIG. 24 is another embodiment of the suspension terminal conductor according to the present invention, and this has a characteristic that the comb tooth edges 92-1 and 92-2 are formed in both sides of the longitudinal direction of the rectangular suspension terminal conductor 60 having the width D2 and the height L2, and the rectangular slit 86 is bored a the center thereof. In other words, it can be considered as a combination embodiment of the embodiment of FIG. 23 and FIG. 19. In the suspension terminal conductor 60 in which the comb tooth edges 92-1 and 92-2 and the rectangular slit 86 are formed in this manner, whether it is an appearance non-defective product or an appearance defective product can be appropriately determined by viewing the state of each of the solder fillets of the comb tooth edges 92-1 and 92-2 and the rectangular slit 86 in the appearance examination after solder joint with the FPC terminal conductor. Since the solder enters the comb tooth edges 92-1 and 92-2 and the rectangular slit 86, thereby forming the solder fillets, the joint strength can be considerably improved.

FIG. 25 is an explanatory drawing showing another embodiment of the suspension terminal conductor according to the present invention, and this embodiment has a characteristic that four circular slits 94-1 to 94-4 are provided in the longitudinal direction at the center of the rectangular suspension terminal conductor 60 having the width D2 and the height L2. In the suspension terminal conductor 60 in which such circular slits 94-1 to 94-4 are provided, whether it is an appearance non-defective product or an appearance defective product can be determined by the formation state of the solder fillets with respect to the circular slits 94-1 to 94-4 in the appearance examination after solder joint. For example, when solder fillets are formed in all of the circular slits 94-1 to 94-4, or solder fillets are formed in the two circular slits 94-2 and 94-3 at the center, it can be determined to be an appearance non-defective product. Meanwhile, when a solder fillet is not formed in any of the circular slits 94-1 to 94-4, or a solder fillet is formed merely in one of them, it can be determined to be an appearance defective product. The joint strength can be improved by forming the solder fillets in the circular slits 94-1 to 94-4.

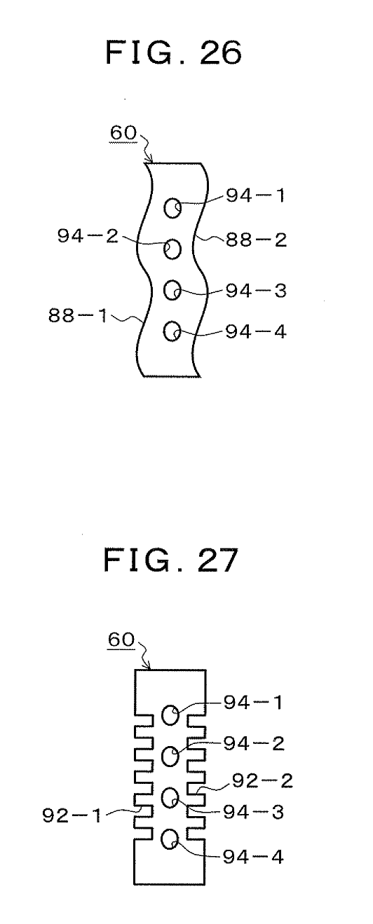

FIG. 26 is an explanatory drawing showing another embodiment of the suspension terminal conductor according to the present invention, and the suspension terminal conductor 60 of this embodiment has a characteristic that the wave-shape edges 88-1 and 88-2 are formed in the longitudinal-direction both sides of the rectangle, and four circular slits 94-1 to 94-4 are bored in the center thereof in the longitudinal direction. The suspension terminal conductor 60 of this embodiment can be considered to be a combination embodiment of the embodiment of FIG. 21 and FIG. 25. Also in this embodiment, in the appearance examination after solder joint, whether it is an appearance non-defective product or an appearance defective product can be determined by viewing the formation state of the solder fillets with respect to the concave parts of the wave-shape edges 88-1 and 88-2 and the circular slits 94-1 to 94-4 arranged a the center, and, furthermore, the joint strength can be improved by forming the solder fillets.

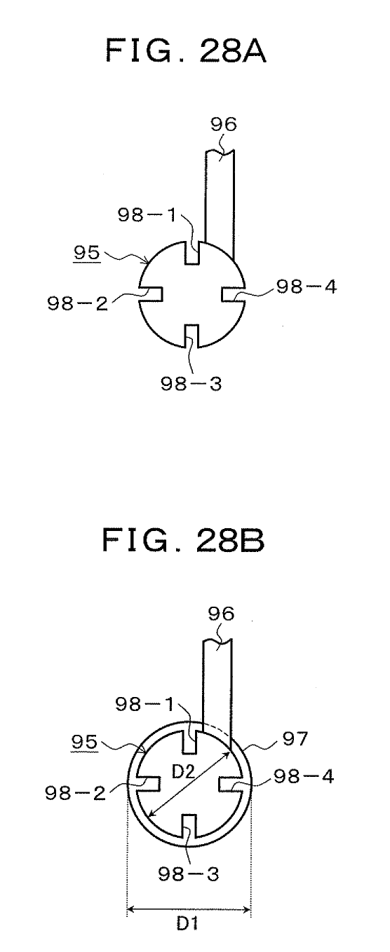

FIG. 27 is an explanatory drawing showing another embodiment of the suspension terminal conductor according to the present invention, and this embodiment has a characteristic that the comb tooth edges 92-1 and 92-2 are formed in the longitudinal-direction both sides of the suspension terminal conductor 60 having the width D2 and the height L2 are formed, and the circular slits 94-1 to 94-4 are provided at the center in the longitudinal direction. In other words, this embodiment can be considered as a combination embodiment of the embodiment of FIG. 23 and FIG. 25. Also in the suspension terminal conductor 60 of this embodiment of FIG. 27, in an examination step after solder joint, whether it is an appearance non-defective product or an appearance defective product can be determined by observing the solder fillets in the comb tooth edges 92-1 and 92-2 and the circular slits 94-1 to 94-4, and, furthermore, the joint strength can be significantly improved by forming the solder fillets. As the suspension terminal conductor of the present embodiment, other than the terminal conductors having the rectangular shapes shown in FIG. 9 and FIG. 16 to FIG. 27, there is a case in which the terminal conductor having a circular shape is used as shown in FIGS. 28A and 28B.

FIG. 28A is an explanatory drawing showing another embodiment of the suspension terminal conductor in the present invention, and this embodiment has a characteristic that notches 98-1 to 98-4 are formed at four locations of the outer periphery of a circular suspension terminal conductor 95 as solder observation windows. A wiring pattern 96 is lead from the suspension terminal conductor 95 in the head side.

FIG. 28B shows the state in which the suspension terminal conductor 95 is positioned with the FPC terminal conductor to be joined with the suspension terminal conductor 95 by soldering. The FPC terminal 97 to be joined with the suspension terminal conductor 95 by soldering has a diameter D1 larger than the diameter D2 of the suspension terminal conductor 95. Also in the embodiment of FIGS. 28A and 28B, in the appearance examination after the suspension terminal conductor 95 is overlapped with the FPC terminal conductor 97 and solder joint is carried out, whether it is an appearance non-defective product or an appearance defective product can be appropriately determined from the formation state of the solder fillet of each of the notches 98-1 to 98-4. The joint strength can be improved by forming the solder fillets with respect to the notches 98-1 to 98-4. Furthermore, although the notches 98-1 to 98-4 are provided in the suspension terminal conductor 95, the diameter D2 is basically unchanged; therefore, the positional alignment and the overlapping amount upon the positioning with the FPC terminal conductor 97 as shown in FIG. 28B can be also appropriately ensured. Note that the shape of the solder joint observation window formed in the suspension terminal conductor 60 used in the present embodiment is not limited to a notch, slit, wave-shape edge, and comb tooth edge shown in the embodiments, but includes arbitrary shapes and combinations thereof, for example, notching, deforming, or removing arbitrary part of the terminal conductor within the range of the basic outline shape 90 shown in FIG. 21 that does not impair the width D2 and the height L2 of the suspension terminal conductor. The embodiments takes a magnetic disk apparatus as an example of an electronic device to which the joint structure by the solder joint according to the present invention not using flux is applied; however, the present invention is not limited thereto but can be applied without modification to an arbitrary electronic device in which a first terminal unit having a plurality of terminal conductors and a second terminal unit are joined by soldering without using flux. Moreover, in the embodiments, the heater chip is pressed and heated when the FPC terminal is joined with the suspension terminal by soldering without using flux; however, a joint structure in which the suspension terminal unit is pressurized by a transparent member such as a glass plate and heated by laser irradiation may be employed. Moreover, the present invention includes arbitrary modifications that do not impair the objects and advantages thereof and is not limited by the numerical values shown in the embodiments.

What is claimed is:

1. An electronic device comprising:
a first terminal unit having a plurality of first terminal conductors arranged on a first insulating layer, a cover layer coating both ends of a surface of the first terminal conductor, and a solder bump precoating an exposed surface of the first terminal conductor;
a second terminal unit having a plurality of second terminal conductors, which are arranged on a second insulating layer so as to be opposed to the first terminal conductors, and an Au plating layer plated on a surface of the second terminal conductor; and
a solder joint structure in which, in the state in which the second terminal conductor of the second terminal unit is opposed to the first terminal conductor of the first terminal unit, heating and melting is carried out while the first terminal conductor is pressed against the solder bump so as to join the first terminal conductor with the second terminal conductor by soldering without using flux, wherein
a solder joint observation window through which the solder joint state by the solder bump can be visually checked from outside via the second insulating layer is provided on the second terminal conductor.

2. The electronic device according to 1, wherein the solder joint observation window of the second terminal conductor forms a notch or a slit through which the solder joint state by the solder bump can be visually checked from outside via the second insulating layer within a range opposed to the outline shape of the first terminal conductor.

3. The electronic device according to claim 1, wherein as the solder joint observation window of the second terminal conductor, a notch is formed at a center of a long side of the terminal conductor, which is rectangular, so that a solder fillet that enters the notch can be visually checked from outside via the second insulating layer.

4. The electronic device according to claim 3, wherein the notch is rectangular, triangular, or semi-circular.

5. The electronic device according to claim 1, wherein as the solder joint observation window of the second terminal conductor, a slit is bored at the center of the rectangular terminal conductor so that a solder fillet that enters the slit can be visually checked from outside via the second insulating layer.

6. The electronic device according to claim 5, wherein the slit is rectangular, oval, circular, or arrangement of a plurality of circles.

7. The electronic device according to claim 1, wherein as the solder joint observation window of the second terminal conductor, a long side of the terminal conductor, which is rectangular, is formed into a wave shape so that a solder fillet that enters a concave part of the wave shape can be visually checked from outside via the second insulating layer.

8. The electronic device according to claim 1, wherein as the solder joint observation window of the second terminal conductor, a long side of the terminal conductor, which is rectangular, is formed into a wave shape, and a slit is bored at the center so that a solder fillet that enters the concave part of the wave shape and the slit can be visually checked from outside via the second insulating layer.

9. The electronic device according to claim 1, wherein as the solder joint observation window of the second terminal conductor, a long side of the terminal conductor, which is rectangular, is formed into a comb tooth shape so that a solder fillet that enters the comb tooth shape can be visually checked from outside via the second insulating layer.

10. The electronic device according to claim 1, wherein as the solder joint observation window of the second terminal conductor, a long side of the terminal conductor, which is rectangular, is formed into a comb tooth shape, and a slit is bored at the center so that a solder fillet that enters the comb tooth shape and the slit can be visually checked from outside via the insulating layer.

11. The electronic device according to claim 1, wherein the planar shape of the first terminal conductor and the second terminal conductor is circular, and as the solder joint observation shape of the second terminal conductor, one or a plurality of notch is formed in the outer periphery of the circular terminal conductor so that a solder fillet that enters the notch can be visually checked from outside via the second insulating layer.

12. The electronic device according to claim 1, wherein
the electronic device is a magnetic disk apparatus which moves a head to an arbitrary position of a disk medium by a rotary actuator and records or reproduces data;
The first terminal unit is provided on a flexible printed board of which one end is fixed to the rotary actuator and the other end thereof is connected to a circuit unit in a chassis fixed side;
the second terminal unit is provided in the tail unit of a suspension supporting the head with respect to the rotary actuator; and
the first terminal unit of the flexible printed board is joined with the second terminal of the suspension tail unit by soldering.

13. A manufacturing method of an electronic device comprising:
a first step of having a first terminal unit having a plurality of first terminal conductors arranged on a first insulating layer, a cover layer coating both ends of a surface of the first terminal conductor, and a solder bump precoating an exposed surface of the first terminal conductor and fixing and disposing the first terminal unit at an operation position;
a second step of having a second terminal unit having a plurality of second terminal conductors, which are arranged on a second insulating layer so as to be opposed to the first terminal conductors and have a solder joint observation window through which a solder joint state can be visually checked from outside via the second insulating layer, and an Au plating layer plated on a surface of the second terminal conductor and positioning the second terminal conductor of the second terminal unit to an operation position opposed to the first terminal conductor of the first terminal unit;
a third step of carrying out heating and melting while the second terminal conductor of the second terminal unit is pressed against the solder bump of the first terminal unit so as to join the first terminal conductor with the second terminal conductor by soldering without using flux; and
a fourth step of observing and examining the solder joint state by the solder bump from outside via the second insulating layer according to the solder joint visual shape of the second terminal conductor.

14. The manufacturing method according to claim 13, wherein the solder joint observation window of the second terminal conductor forms a notch or a slit through which the solder joint state by the solder bump can be visually checked from outside via the second insulating layer within a range opposed to the outline shape of the first terminal conductor.

15. The manufacturing method according to claim 13, wherein as the solder joint observation window of the second terminal conductor, a notch is formed at a center of a long side of the terminal conductor, which is rectangular, so that a solder fillet that enters the notch can be visually checked from outside via the second insulating layer.

16. The electronic method according to claim 13, wherein as the solder joint observation window of the second terminal conductor, a slit is bored at the center of the rectangular terminal conductor so that a solder fillet that enters the slit can be visually checked from outside via the second insulating layer.

17. The manufacturing method according to claim 13, wherein as the solder joint observation window of the second terminal conductor, a long side of the terminal conductor, which is rectangular, is formed into a wave shape so that a solder fillet that enters a concave part of the wave shape can be visually checked from outside via the second insulating layer.

18. The manufacturing method according to claim 13, wherein as the solder joint observation window of the second terminal conductor, a long side of the rectangle is formed into a comb tooth shape so that a solder fillet that enters the comb tooth shape can be visually checked from outside via the second insulating layer.

19. The manufacturing method according to claim 13, wherein the planar shape of the first terminal conductor and the second terminal conductor is circular, and as the solder joint observation window of the second terminal conductor, one or a plurality of notch is formed in the outer periphery of the circular terminal conductor so that a solder fillet that enters the notch can be visually checked from outside via the second insulating layer.

20. The manufacturing method according to claim 13, wherein
the electronic device is a magnetic disk apparatus which moves a head to an arbitrary position of a disk medium by a rotary actuator and records or reproduces data;
The first terminal unit is provided on a flexible printed board of which one end is fixed to the rotary actuator and the other end is connected to a circuit unit in a chassis fixed side;
the second terminal unit is provided in the tail unit of a suspension supporting the head with respect to the rotary actuator; and
the first terminal unit of the flexible printed board is joined with the second terminal of the suspension tail unit by soldering.
